(19) United States
(12) Patent Application Publication
(10) Pub. No.: US 2015/0325145 A1
(43) Pub. Date: Nov. 12, 2015

(54) Method and Apparatus for Teaching Language

(71) Applicant: Seoungwon SEO, Los Angeles, CA (US)

(72) Inventor: Seoungwon SEO, Los Angeles, CA (US)

(21) Appl. No.: 14/271,274

(22) Filed: May 6, 2014

(51) Int. Cl. G09B 19/06; G06F 17/20

(52) U.S. Cl. CPC G09B 19/06; G06F 17/20

(57) ABSTRACT

A language teaching or learning apparatus comprises a memory, a display, an input device, and a controller. The memory device stores target language characters or words in text, images and animation video clips showing meanings of the plurality of characters or words, and intonation graphic symbols showing intonations for the characters or words. The input device allows a user to input control signals or commands. The controller activates the input device such that the user inputs control signals to select one or more target language characters or words and display the selected target language characters or words and corresponding images or animation video clips along with corresponding intonation graphic symbols on the display in a predetermined manner. The user watch the target language characters, the images and animation video clips, and the intonation graphic symbols in ways controlled by the controller.

### BACKGROUND OF THE INVENTION

The present invention relates to a method and apparatus for teaching a language.

With the development of communication and transportation, the world became a big but well-connected, kind of village. The chance to meet or communicate directly with foreigners is increased a lot.

Therefore, learning or teaching foreign languages becomes a necessity these days.

Especially, the popularity and usage of the Chinese language has soared. At the same, however, the Chinese language is notoriously difficult to learn due to its structure, intonation, and characters, to name a few.

This invention is to solve some of the problems.

### SUMMARY OF THE INVENTION

The present invention contrives to solve the disadvantages of the prior art.

An object of the invention is to provide a method and apparatus for teaching a language.

An aspect of the invention provides an apparatus for teaching language.

The apparatus comprises a memory, a display, an input device, and a controller.

The memory device is configured for storing a plurality of target language characters or words in text, a plurality of images and animation video clips showing meanings of the plurality of characters or words, and a plurality of intonation graphic symbols showing intonations for the plurality of characters or words.

The display is configured for displaying a text, a corresponding image or animation video clip, and a corresponding intonation graphic symbol.

The input device is configured for allowing a user to input control signals or commands.

The controller is configured for activating the input device such that the user inputs control signals to select one or more target language characters or words and displaying the selected target language characters or words and corresponding images or animation video clips along with corresponding intonation graphic symbols on the display in a predetermined manner.

The user watches the target language characters, the images and animation video clips, and the intonation graphic symbols in ways controlled by the controller.

The memory device may or can store the target language characters or words, the images or animation video clips, and the intonation graphic symbols in one or more database.

The display may be further configured for arranging and displaying the text, the corresponding image or animation video clip, and the corresponding intonation graphic symbol in a box thereon.

The input device may comprise a keyboard, a mouse, or a scratch pad, wherein the input device is further configured for generating control signals or commands for selecting one or more target language characters or words.

The controller may be further configured for responding to and controlling the memory, the display, and the input device such that the text, the corresponding image or animation video clip, and the corresponding intonation graphic symbol are displayed all at once, or one by one serially automatically with predetermined intervals or in prompted way through a stroke in the input device.

The intonation graphic symbol may be displayed so as to overlap with the images or animation video clip.

The intonation graphic symbol may be animated.

The intonation graphic symbol may have different proper color according to different intonations.

The apparatus may further comprise a speaker connected to and controlled by the controller so as to generates a corresponding pronunciation for the target language character or word.

The memory device may further store a plurality of pronunciation audio clips for the plurality of target language characters or words.

Each of the pronunciation audio clips may be assigned to a clickable icon on the display for activating.

For a specific target language character or word selected through the input device by the user, one or more base language texts stored in the memory device are displayed along with some of the selected specific target language character or word, the corresponding images or animation video clip, and the corresponding intonation graphic symbol.

One or more base language texts may comprise meaning and pronunciation of the selected target language characters or word.

For the selected specific target language character or word, the meaning and pronunciation in base language texts, the corresponding image or animation video clip, the corresponding intonation graphic symbol, and the pronunciation icon may be displayed.

The image or animation video clip may fade out or in gradually.

The meaning in base language may be replaced with the target language character or word when the image or animation video clip fades out substantially completely.

The intonation graphic symbol may be transparent when the meaning and pronunciation in base language texts are displayed along with the corresponding image or animation video clip solid.

The plurality of target language characters or words may comprise nouns, verbs, adjectives, adverbs, pronouns, idioms, and sentences.

The target language may comprise Chinese or Korean.

Another aspect of the invention provides a method for teaching Chinese using the apparatus shown in the above. The method comprise steps for:

the user's selecting a specific Chinese character or word;

displaying the selected specific Chinese character or word or meaning and pronunciation thereof in base language texts along with a corresponding image or animation video clip on the display;

playing a corresponding pronunciation audio clip on the user's request through the input device;

fading out or in of the image or animation video clip; and

animating with various combination of the selected specific Chinese character or word or meaning and pronunciation thereof in base language texts along with a corresponding image or animation video clip.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features, aspects and advantages of the present invention will become better understood with reference to the accompanying drawings, wherein:

FIG. 1 is a block diagram showing an apparatus for teaching foreign language according to an embodiment of the present invention;

FIG. 2 shows serial snapshots of a display for showing how to organize related information about two Chinese characters according to another embodiment of the present invention;

FIG. 3 shows serial snapshots of a display for showing how to organize related information about another two Chinese characters;

FIG. 4 shows serial snapshots of a display for showing how to organize related information about still another two Chinese characters; and

FIG. 5 is a flowchart showing a method for teaching the Chinese language according to still another embodiment of the present invention.

### DETAILED DESCRIPTION EMBODIMENTS OF THE INVENTION

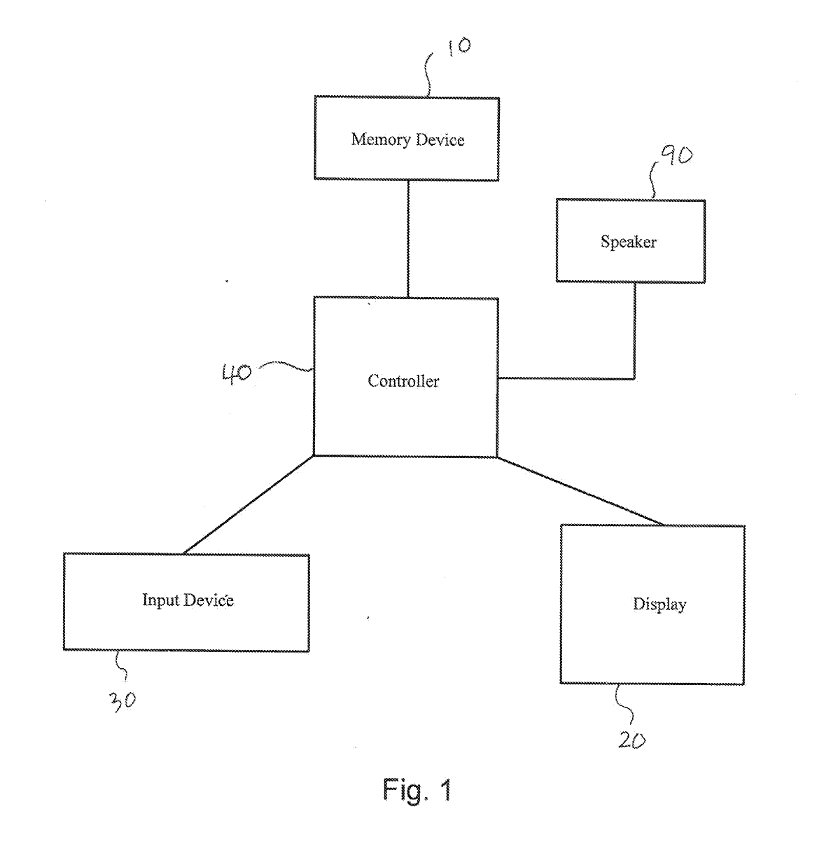

FIG. 1 shows a block diagram of an apparatus 100 for teaching foreign language according to an embodiment of the present invention.

The apparatus 100 for teaching language according to an aspect of the invention is provided in FIG. 1.

The apparatus 100 comprises a memory 10, a display 20, an input device 30, and a controller 40.

The memory device 10 is configured for storing a plurality of target language characters or words in text, a plurality of images and animation video clips showing meanings of the plurality of characters or words, and a plurality of intonation graphic symbols showing intonations for the plurality of characters or words. In certain embodiments, the entire information may be organized in a predetermined data structure such as a database.

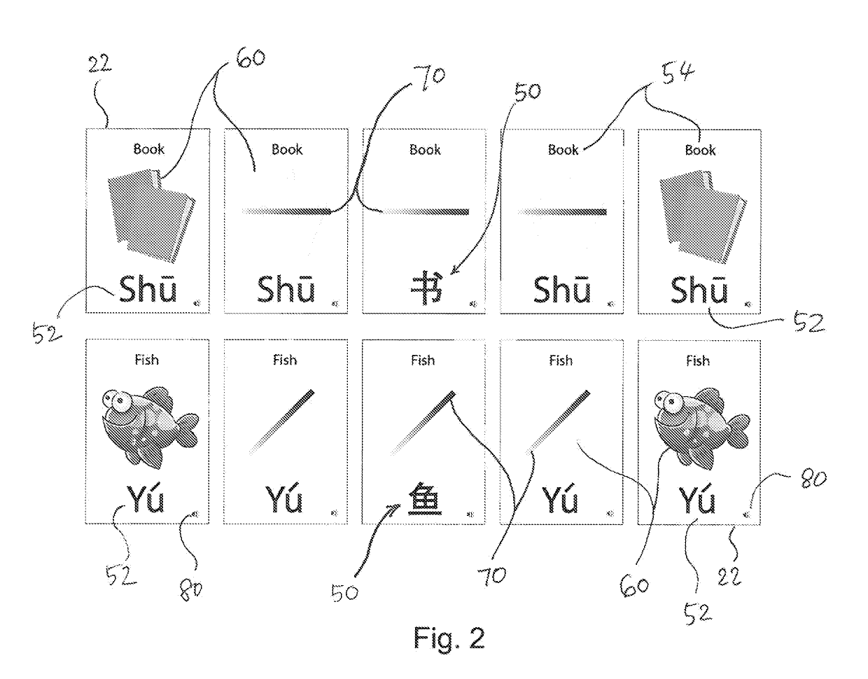

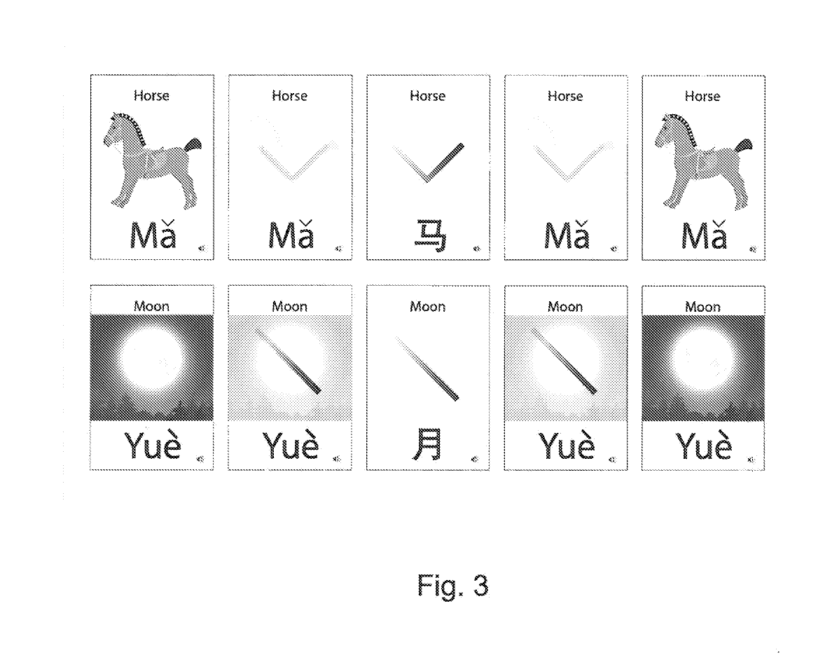

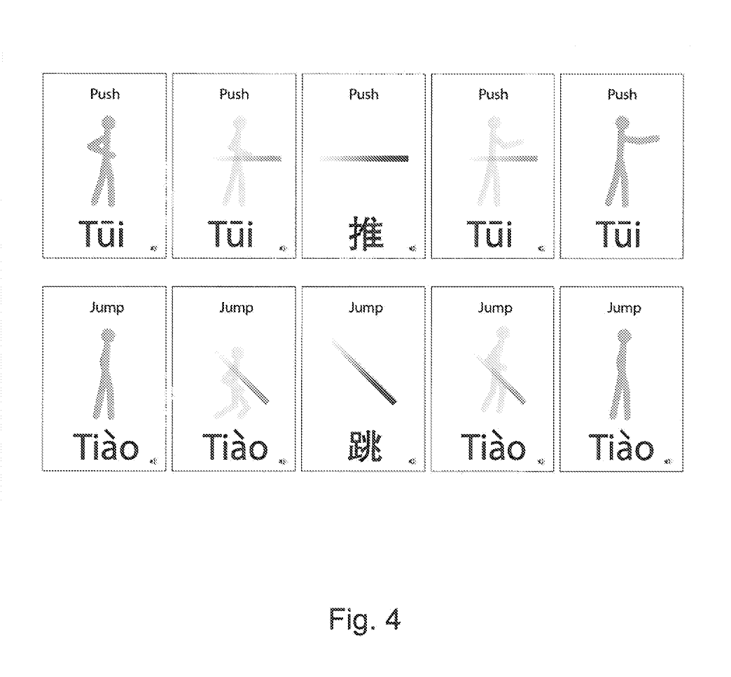

FIGS. 2 through 4 show serial snapshots of the display 20 for showing how to organize related information about Chinese characters in the apparatus 100 according to embodiments of the present invention.

Even though FIGS. 2 to 4 illustrate examples for the Chinese language, the invention can be applied to any other foreign languages.

The display 20 is configured for displaying a text, a corresponding image or animation video clip, and a corresponding intonation graphic symbol.

The input device 30 is configured for allowing a user to input control signals or commands. Of course, the input device 30 can interact with the display 20 to facilitate inputting. For example, the input device 30 can be used to select texts, words, sentences, symbols, or pictures displayed on the display 20 by the user.

The controller 40 is configured for activating the input device 30 such that the user inputs control signals to select one or more target language characters or words 50 and displaying the selected target language characters or words 50 and corresponding images or animation video clips 60 along with corresponding intonation graphic symbols 70 on the display 20 in a predetermined manner as shown in FIGS. 2 to 4.

For example, each of boxes in FIG. 2 can be a screenshot. In certain embodiments, the display 20 may be a screen for an information processing device such as a desktop computer, a notebook computer, a tablet PC, or a smart phone.

The user watches the target language characters 50, the images and animation video clips 60, and the intonation graphic symbols 70 in ways controlled by the controller.

The memory device 10 may or can store the target language characters or words 50, the images or animation video clips 60, and the intonation graphic symbols 70 in one or more database.

The display 20 may be further configured for arranging and displaying the text, the corresponding image or animation video clip, and the corresponding intonation graphic symbol in a box 22 thereon. Of course, the box 22 may be just a visible or invisible physical border between the display 20 and the displayed images.

The input device 30 may comprise a keyboard, a mouse, or a scratch pad, and the input device 20 is further configured for generating control signals or commands for selecting one or more target language characters or words 50.

The controller 40 may be further configured for responding to and controlling the memory 10, the display 20, and the input device 30 such that the text 50, the corresponding image or animation video clip 60, and the corresponding intonation graphic symbol 70 are displayed all at once, or one by one serially automatically with predetermined intervals or in prompted way through a stroke in the input device. For example, each row of the screenshots in FIGS. 2 to 4 can be displayed serially with predetermined intervals inbetween on the display 20 one by one. In certain embodiments, the Chinese character 50 may be replaced with a pronunciation-representation 52 in letters of the other foreign language, English in this illustrated embodiment.

The intonation graphic symbol 70 may be displayed so as to overlap with the images or animation video clip 60.

The intonation graphic symbol 70 may be animated as shown in FIG. 2, where the intonation graphic symbol 70 may be faded out gradually, leaving the corresponding image or animation video clip 60 alone.

The intonation graphic symbol 70 may have different proper colors for each according to different intonations. In the illustrated embodiments in FIGS. 2 to 4, the intonation graphic symbol 70 has the well-known four intonations of the Chinese language.

The apparatus 100 may further comprise a speaker 90 connected to and controlled by the controller 40 so as to generates a corresponding pronunciation for the target language character or word 50.

The memory device 10 may further store a plurality of pronunciation audio clips for the plurality of target language characters or words 50.

Each of the pronunciation audio clips may be assigned to a clickable icon 80 on the display 20 for activating.

For a specific target language character or word 50 selected through the input device 30 by the user, one or more base language texts 54 stored in the memory device 10 are displayed along with some of the selected specific target language character or word 50, the corresponding images or animation video clip 60, and the corresponding intonation graphic symbol 70. In the illustrated embodiment, the base language is English.

One or more base language texts 54 may comprise meaning and pronunciation of the selected target language characters or word 50.

For the selected specific target language character or word 50, the meaning and pronunciation in base language texts 52, 54, the corresponding image or animation video clip 60, the corresponding intonation graphic symbol 70, and the pronunciation icon 80 may be displayed in a screen. Of course, the controller 40 can control the displaying behaviors; which ones be displayed or omitted in which orders with which intervals and the like.

The image or animation video clip 60 may fade out or in gradually, or can be synchronized with the pronunciation. That is, when the user clicked any predetermined spots on the screen, the animation and playing of the audio clips are activated in coordination.

The meaning 54 in base language may be replaced with the target language character or word 50 when the image or animation video clip 60 fades out substantially completely.

The intonation graphic symbol 70 may be transparent when the meaning and pronunciation 54 in base language texts are displayed along with the corresponding image or animation video clip 70 solid.

The plurality of target language characters or words 50 may comprise nouns, verbs, adjectives, adverbs, pronouns, idioms, and sentences as shown in FIGS. 2 to 4.

The target language may comprise Chinese or Korean.

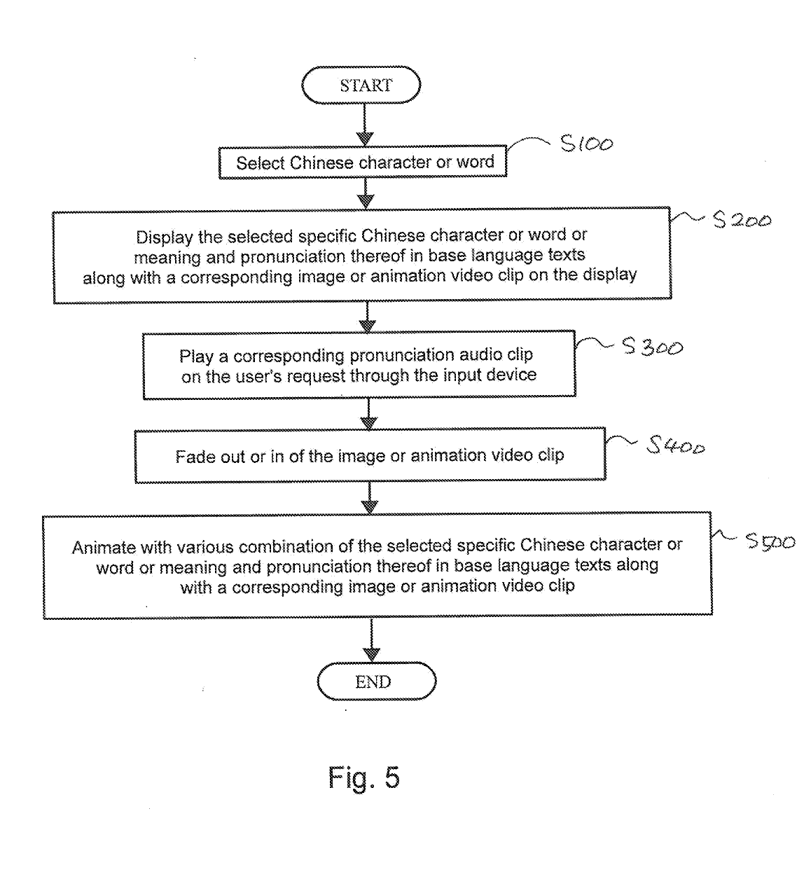

As shown in FIG. 5, another aspect of the invention provides a method for teaching Chinese using the apparatus shown in the above. The method comprise steps for:

the user's selecting a specific Chinese character or word (S100);

displaying the selected specific Chinese character or word or meaning and pronunciation thereof in base language texts along with a corresponding image or animation video clip on the display (S200);

playing a corresponding pronunciation audio clip on the user's request through the input device (S300);

fading out or in of the image or animation video clip (S400); and

animating with various combination of the selected specific Chinese character or word or meaning and pronunciation thereof in base language texts along with a corresponding image or animation video clip (S500).

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An apparatus for teaching language comprising:
a memory device configured for storing a plurality of target language characters or words in text, a plurality of images and animation video clips showing meanings of the plurality of characters or words, and a plurality of intonation graphic symbols showing intonations for the plurality of characters or words;
a display configured for displaying a text, a corresponding image or animation video clip, and a corresponding intonation graphic symbol;
an input device configured for allowing a user to input control signals or commands; and
a controller configured for activating the input device such that the user inputs control signals to select one or more target language characters or words and displaying the selected target language characters or words and corresponding images or animation video clips along with corresponding intonation graphic symbols on the display in a predetermined manner,
wherein the user watch the target language characters, the images and animation video clips, and the intonation graphic symbols in ways controlled by the controller.

2. The apparatus of claim 1, wherein the memory device stores the target language characters or words, the images or animation video clips, and the intonation graphic symbols in one or more database.

3. The apparatus of claim 1, wherein the display is further configured for arranging and displaying the text, the corresponding image or animation video clip, and the corresponding intonation graphic symbol in a box thereon.

4. The apparatus of claim 1, wherein the input device comprises a keyboard, a mouse, or a scratch pad, wherein the input device is further configured for generating control signals or commands for selecting one or more target language characters or words.

5. The apparatus of claim 1, wherein the controller is further configured for responding to and controlling the memory, the display, and the input device such that the text, the corresponding image or animation video clip, and the corresponding intonation graphic symbol are displayed all at once, or one by one serially automatically with predetermined intervals or in prompted way through a stroke in the input device.

6. The apparatus of claim 1, wherein the intonation graphic symbol is displayed so as to overlap with the images or animation video clip.

7. The apparatus of claim 6, wherein the intonation graphic symbol is animated.

8. The apparatus of claim 6, wherein the intonation graphic symbol has different proper color according to different intonations.

9. The apparatus of claim 1, further comprising a speaker connected to and controlled by the controller so as to generates a corresponding pronunciation for the target language character or word.

10. The apparatus of claim 9, wherein the memory device further stores a plurality of pronunciation audio clips for the plurality of target language characters or words.

11. The apparatus of claim 10, wherein each of the pronunciation audio clips is assigned to a clickable icon on the display for activating.

12. The apparatus of claim 11, wherein for a specific target language character or word selected through the input device by the user, one or more base language texts stored in the memory device are displayed along with some of the selected specific target language character or word, the corresponding images or animation video clip, and the corresponding intonation graphic symbol.

13. The apparatus of claim 12, wherein one or more base language texts comprise meaning and pronunciation of the selected target language characters or word.

14. The apparatus of claim 13, wherein for the selected specific target language character or word, the meaning and pronunciation in base language texts, the corresponding image or animation video clip, the corresponding intonation graphic symbol, and the pronunciation icon are displayed.

15. The apparatus of claim 14, wherein the image or animation video clip fades out or in gradually.

16. The apparatus of claim 15, wherein the meaning in base language is replaced with the target language character or word when the image or animation video clip fades out substantially completely.

17. The apparatus of claim 15, wherein intonation graphic symbol is transparent when the meaning and pronunciation in base language texts are displayed along with the corresponding image or animation video clip solid.

18. The apparatus of claim 1, wherein the plurality of target language characters or words comprise nouns, verbs, adjectives, adverbs, pronouns, idioms, and sentences.

19. The apparatus of claim 1, wherein the target language comprises Chinese.

20. A method for teaching Chinese using the apparatus of claim 19, the method comprising steps for:
the user's selecting a specific Chinese character or word;
displaying the selected specific Chinese character or word or meaning and pronunciation thereof in base language texts along with a corresponding image or animation video clip on the display;
playing a corresponding pronunciation audio clip on the user's request through the input device;
fading out or in of the image or animation video clip; and
animating with various combination of the selected specific Chinese character or word or meaning and pronunciation thereof in base language texts along with a corresponding image or animation video clip.
